(19) United States
(12) Patent Application Publication
(10) Pub. No.: US 2010/0122056 A1
(43) Pub. Date: May 13, 2010

(54) Method and Device for Securely Storing and Securely Reading User Data

(75) Inventors: Rudolf Gerber, Konigsfeld (DE); Manfred Götz, Gottingen (DE); Franz Kimmich, Schramberg (DE)

Correspondence Address: COHEN, PONTANI, LIEBERMAN & PAVANE LLP, 551 FIFTH AVENUE, SUITE 1210, NEW YORK, NY, 10176, US

(73) Assignee: Continental Automotive GmbH, Hannover (DE)

(21) Appl. No.: 12/527,383

(22) PCT Filed: Jan. 21, 2008
(86) PCT No.: PCT/EP2008/050600

§ 371 Date: Aug. 14, 2009

(30) Foreign Application Priority Data
Feb. 16, 2007 (DE) 10 2007 008 293.4

(51) Int. Cl. G06F 12/14; G06F 12/00

(52) U.S. Cl. 711/163; 711/E12.001; 711/E12.091

(57) ABSTRACT

User data is stored in at least one record in at least one predefined, logic data storage area. One respective record ID is assigned to the at least one record. The record ID includes a uniqueness stamp that is unique in the respective predefined data storage area, a unique ID of the predefined data storage area in which the respective record is stored, and a logic position of the respective record within the respective predefined data storage area. A record test value is determined and stored for the user data and the respective associated record ID of the respective record. Data storage area information containing the ID of the respective predefined data storage area and data on at least one value range of the uniqueness stamps of the records currently stored in the respective predefined data storage area is assigned to the respective predefined data storage area.

### PRIORITY CLAIM

This is a U.S. national stage of Application No. PCT/EP2008/050600, filed on 21 Jan. 2008, which claims Priority to the German Application No.: 10 2007 008 293.4, filed: 16 Feb. 2007, the contents of both being incorporated herein by reference.

### BACKGROUND OF THE INVENTION

1. Field of the Invention

The invention relates to a method and apparatus for protected storage and protected reading of user data, particularly in a digital tachograph.

2. Prior Art

WO 2005/098567 A1 discloses an arrangement having an integrated circuit. The integrated circuit comprises an encryption unit as a functional module that is used to encrypt and decrypt data or program code. In addition, to protect against manipulation, a security sensor system is provided as a functional module used to monitor at least one operating parameter for the integrated circuit. A protective layer may be produced on the integrated circuit and monitored. The protective layer needs to be destroyed to effect mechanical access to the structure of the integrated circuit. When destruction of the protective layer is recognized, the data to be protected is erased.

US 2005/0050342 A1 discloses a data storage system for secure storage of information. The data storage system protects against modification of information, since a cryptographic test value, such as a checksum, is a function of the data, of a cryptographic key and of an address of the data record. The information is saved securely, with random-sample access made possible for updating the data record.

### SUMMARY OF THE INVENTION

An object of the invention is to provide a method and an apparatus for protected storage and a method and an apparatus for protected reading of user data, said methods and apparatuses being reliable.

In line with a first embodiment of the invention, a method and an appropriate apparatus for the protected storage of user data is disclosed. The user data is stored in at least one data record in at least one prescribed logical data area. The at least one data record is assigned a respective data record identifier that comprises an explicitness stamp or uniqueness stamp that is explicit or unique in the respective prescribed data area, an explicit data area identifier for the prescribed data area in which the respective data record is stored, and a logical position for the respective data record within the respective prescribed data area. The data record identifier is stored. The user data and the respective associated data record identifier from the respective data record have a data record test value ascertained and stored for them. The respective prescribed data area is assigned a data area information item which comprises the data area identifier from the respective prescribed data area. In addition, the data area information item comprises information relating to at least one range of values for the explicitness stamps of the data records currently stored in the respective prescribed data area. The respective data area information item is stored securely or in protected form.

Secure storage means that the data stored in this manner is stored in a manner protected against manipulation. The secure storage is preferably effected in a secure memory in which the data electrically and/or mechanically protected against manipulation. Secure storage means that the data stored in this manner can be checked for manipulations, for example by checking a cryptographically ascertained test value such as the data record test value or a cryptographically ascertained digital signature. The protected storage has the advantage that the data stored in this manner is easily and reliably checked for integrity and the data does not have to be stored in the secure memory. Based on the generally high price of secure memory, costs can thus be saved. The secure or protected storage particularly comprises cryptographically secure or protected storage, that is to say particularly the use of cryptographic keys and/or cryptographic algorithms to assure security.

By providing the data record test value, it is possible to reliably recognize manipulation of the user data and/or the associated data record identifier. The data area identifier can be used to reliably recognize interchange of a data record between different prescribed data areas. In addition, the logical position of the data record within the associated, prescribed data area is used to reliably recognize interchange of data records. The explicitness stamp and the information item relating to the at least one range of values of the explicitness stamps can be used to reliably recognize what is known as a replay attack. During a replay attack, an old data record, which has become invalid but which has a correct data record test value, is output as a more recent data record.

The cited measures mean that the user data is stored in protected form. Manipulations of user data is recognized easily and reliably. In addition, the provision of the data record identifier, of the data record test value and of the data area information item allows rapid access to the user data and, rapid, protected writing and rapid, protected reading and checking of the user data. A further advantage is that the user data and the data record identifier do not have to be stored in the secure memory.

In one embodiment, the protected storage of the respective data area information item comprises ascertaining and storing securely or in protected form a common or respective data area test value for at least one data area information item from at least one prescribed data area. The advantage is that manipulations on the at least one data area information item can be recognized reliably. In addition, the at least one data area information item does not need to be stored in the secure memory. This allows the secure memory to be produced at a particularly small storage capacity and to be correspondingly inexpensive. In addition, the integrity of the at least one data area information item can be checked easily, quickly and reliably.

In a further embodiment, the respective prescribed data area has an associated exclusion list for invalid data records. The respective data record that has become invalid is recorded in the exclusion list. The exclusion list is stored securely or in protected form. This allows reliable prevention of a replay attack with the invalid data record. In addition, it is thus possible to erase a data record, which means that it becomes invalid, without endangering the integrity of the data records stored in the associated prescribed data area.

It is advantageous if the recording of the respective data record which has become invalid in the exclusion list enters the associated explicitness stamp into the exclusion list, or said explicitness stamp is taken as a basis for entering at least one range of values for explicitness stamps which have become invalid into the exclusion list or expanding it in the exclusion list. This has the advantage that a storage space requirement for the exclusion list is low, particularly when the at least one range of values for explicitness stamps which have become invalid is provided. In addition, the exclusion list can thus be searched particularly quickly.

In a further refinement, a current time stamp is ascertained and stored in the respective data record identifier. This allows time-related data records to be ascertained very easily and quickly, particularly in two or more of the prescribed data areas.

According to one embodiment of the invention, a method and an appropriate apparatus for the protected reading of user data is provided. The user data from at least one data record is read, said data being stored in at least one prescribed, logical data area. A data record identifier associated with the at least one data record is read, said data record identifier comprising an explicitness stamp which is explicit in the respective prescribed data area, an explicit data area identifier for the prescribed data area in which the respective data record is stored, and a logical position for the respective data record within the respective prescribed data area. A data record test value is read, said data record test value being stored for the user data and the associated data record identifier from the respective data record. An appropriate comparison data record test value is ascertained. A data area information item associated with the respectively prescribed data area is read, said data area information item comprising the data area identifier from the respective prescribed data area and information relating to at least one range of values for the explicitness stamps of the data records currently stored in the respective prescribed data area. An integrity for the user data from the respective read data record is checked on the basis of the respective data record identifier, the respective data record test value, the respective comparison data record test value, and the associated data area information item.

Protected reading means that the data read is checked for manipulations by checking a cryptographically ascertained test value such as the data record test value or a cryptographically ascertained digital signature.

The data record test value can be used to reliably recognize manipulation of the user data and/or the associated data record identifier. The data area identifier can be used to reliably recognize interchange of a data record between different prescribed data areas. In addition, the logical position of the data record within the associated prescribed data area can be used to reliably recognize interchange of data records. The explicitness stamp and the information item relating to the at least one range of values for the explicitness stamps can be used to reliably recognize what is known as a replay attack. During a replay attack, an old data record which has become invalid but which has a correct data record test value is output as a more recent data record, for example.

The cited measures mean that the user data is read in protected form. Manipulations of the user data are recognized easily and reliably. In addition, the data record identifier, the data record test value and the data area information item allow rapid access to the user data and, in particular, rapid, protected reading and checking of the user data.

In one advantageous embodiment, at least one common or respective data area test value for at least one data area information item from at least one prescribed data area is read. A respective corresponding common or respective comparison data area test value is ascertained for the at least one data area information item from the at least one prescribed data area. The integrity of the user data in the respective data record is checked on the basis of the at least one read data area test value and the at least one comparison data area test value. The advantage is that manipulations on the at least one data area information item are recognized reliably. In addition, the integrity of the at least one data area information item can be checked easily, quickly and reliably.

In a further embodiment, an exclusion list for data records which have become invalid that is associated with the respective prescribed data area is searched for recording of the respective read data record. The integrity of the user data is checked in the respective data record on the basis of the data records which have become invalid which are recorded in the exclusion list. The exclusion list associated with the respective prescribed data area is read securely or in protected form, that is to say read from a manipulation-proof memory and/or checked for its integrity. In other words, the check on the integrity of the user data may also comprise the check on the integrity of the exclusion list. As a result, it is possible to reliably prevent a replay attack with the invalid data record. In addition, an erased data record which has become invalid as a result of the erasure is unable to endanger the integrity of the data stored in the associated prescribed data area.

In this connection, it is advantageous if the integrity of the user data in the respective data record is checked based on the explicitness stamps which have become invalid which are entered in the exclusion list or on the basis of at least one range of values for explicitness stamps which have become invalid which is entered in the exclusion list. This has the advantage that a storage space requirement for the exclusion list is low, particularly when the at least one range of values for explicitness stamps which have become invalid is provided. In addition, the exclusion list can thus be searched particularly quickly.

### BRIEF DESCRIPTION OF THE DRAWINGS

Exemplary embodiments of the invention are explained below with reference to the schematic drawings, in which:

FIG. 1 is a digital tachograph;

FIG. 2 is a first embodiment of a logical data arrangement;

FIG. 3 is a second embodiment of the logical data arrangement;

FIG. 4 is a data record identifier; FIG. 5 is a data area information item;

FIG. 6 is a flowchart for a program for the protected storage of user data; and

FIG. 7 is a flowchart for a program for the protected reading of user data.

Elements which have the same design or function are provided with the same reference symbols throughout the figures.

### DETAILED DESCRIPTION OF THE DRAWINGS

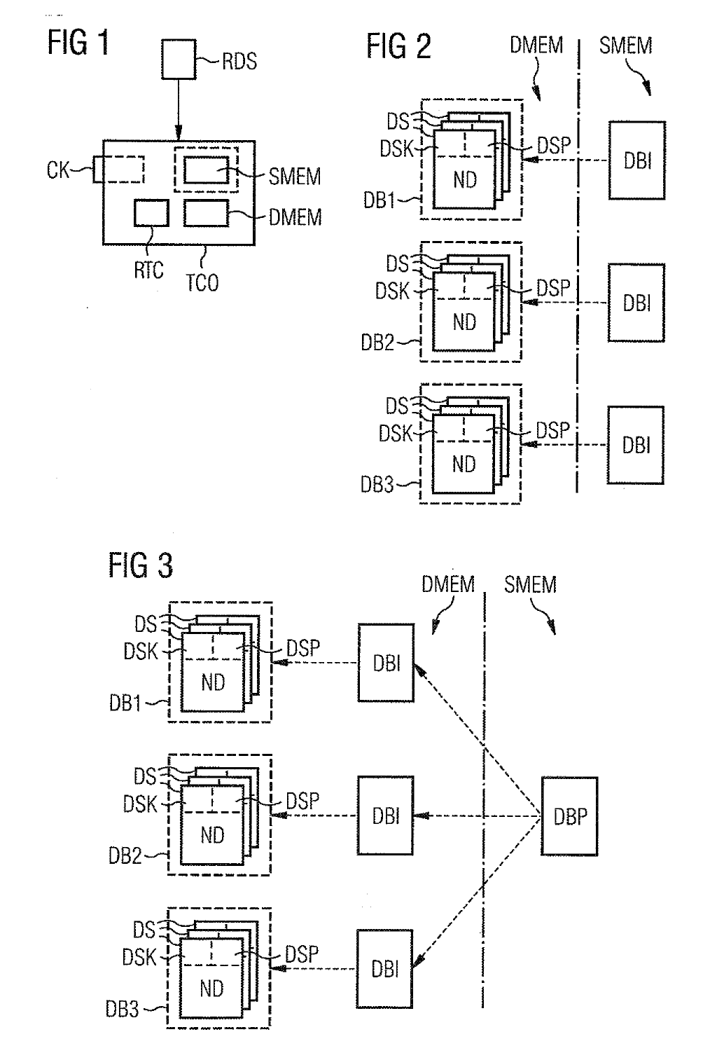

A digital tachograph TCO comprises a secure memory SMEM, a data memory DMEM, a realtime clock RTC and at least one chip card reading unit into which a chip card CK can be inserted. The chip card is a tachograph card or workshop card (FIG. 1). The realtime clock RTC is preferably in a form protected against manipulations and can be set only by authorized people who are able to identify themselves to the tachograph TCO by an appropriate chip card CK, for example the workshop card. The tachograph TCO is coupled to at least one wheel speed sensor RDS for detecting a speed of travel for a vehicle in which the tachograph TCO is arranged. The tachograph TCO can also be referred to as an apparatus for writing and/or reading user data ND.

The secure memory SMEM is preferably electrically and/or mechanically protected against manipulations of the data stored therein. By way of example, the secure memory SMEM is provided with a protective layer or with a security grill that can be monitored electrically. If the protective layer or the security grill is damaged, access to the data stored in the secure memory SMEM can be prevented, for example, by erasing the data. The secure memory SMEM may also be in a different form.

The data memory DMEM is preferably in non-secure form, that is to say particularly not electrically and/or mechanically protected against manipulation. Based on the generally higher price of the secure memory SMEM in comparison with the data memory DMEM, the secure memory SMEM has only a low storage capacity in comparison with the data memory DMEM. However, the data stored in the data memory DMEM also needs to be protected. In particular, date manipulations need to be recognized reliably. The tachograph TCO is therefore designed to store data in the data memory DMEM in protected form and to read the date therefrom in protected form. The data stored in the data memory DMEM is stored so as to be able to be cryptographically checked for manipulations and is checked during reading to establish the integrity of the read data or to be able to recognize manipulations.

The data stored in the data memory DMEM comprise the user data ND, which typically includes the recorded speed of travel. The chip card CK may comprise a further secure memory and a further data memory, corresponding to the secure memory SMEM and the data memory DMEM in the tachograph TCO. Accordingly, data can also be stored in the further data memory of the chip card CK in protected form or read therefrom in protected form.

FIG. 2 is a first embodiment of a logical data arrangement for data in the data memory DMEM and the secure memory SMEM. A corresponding logical data arrangement of data may also be provided in the further data memory of the chip card CK and the further secure memory of the chip card CK. The data memory DMEM contains at least one prescribed data area for storing at least one respective data record DS. By way of example, FIG. 2 shows a first prescribed data area DB1, a second prescribed data area DB2 and a third prescribed data area DB3. However, it is also possible for just one prescribed data area to be provided. In addition, two or more than three prescribed data areas may also be provided.

The different prescribed data areas may be provided for different data types or data structures. However, there may also be a plurality of prescribed data areas provided for the same data type or for the same data structure. In addition, provision may also be made for different data types or data structures to be stored together in one of the prescribed data areas. By way of example, one the prescribed data areas may be provided for the protected storage of the recorded speed of travel as user data ND. Another of the prescribed data areas may be provided for the protected storage of an insertion time and removal time for the chip card CK into and out of the chip card reading unit of the tachograph TCO as user data ND. It is also possible for other or further user data ND to be stored.

The data records DS stored in the prescribed data areas respectively comprise the user data ND, a data record identifier DSK and a data record test value DSP. The data record test value DSP is formed by the user data ND and the data record identifier DSK from the respective data record DS. The data record test value DSP is preferably formed cryptographically, for example as a digital signature or as a message authentication code, MAC for short. However, the data record test value DSP may be in a different form. The data record identifier DSK and the data record test value DSP are logically associated with the associated data record DS, but do not have to be stored together with the user data ND in the associated, prescribed data area. The data record identifier DSK and the data record test value DSP from the respective data record DS may also be stored at another location, for example on another data storage medium.

The at least one prescribed data area is preferably in the form of a ring memory with a prescribed maximum number MAX_DS of data records DS that can be stored in the respective ring memory, that is to say in the respective prescribed data area. The respective ring memory is distinguished in that data records DS can be stored only at successive, prescribed positions POS. When a new data record DS is stored in the ring memory, the respective oldest data record DS in the ring memory is overwritten when the maximum number MAX_DS of data records DS in the respective ring memory has been reached, that is to say when the respective ring memory is full. The at least one prescribed data area may also be in a different form, however.

For the tachograph TCO, the maximum number MAX_DS of data records DS is preferably prescribed such that the user data ND which is intended to be stored within a prescribed period can be stored in the respective ring memories without the need for older data records DS to be overwritten. By way of example, the prescribed period is one year. However, the prescribed period may also be prescribed to be shorter or longer.

Each respective prescribed data area has a respective associated data area information item DBI. In the first exemplary embodiment, the respective data area information item DBI is stored in the secure memory SMEM. This means that the respective data area information item DBI is protected against manipulation. FIG. 3 shows a second embodiment of the data arrangement. In the second embodiment of the data arrangement, provision is made for the respective data area information item DBI to be stored in the data memory DMEM. To recognize manipulations on one of the data area information items DBI, provision is made for a data area test value DBP to be ascertained for the respective data area information item DBI or jointly for two or more or else for all data area information items DBI and stored in the secure memory SMEM. This means that particularly little storage space is required in the secure memory SMEM.

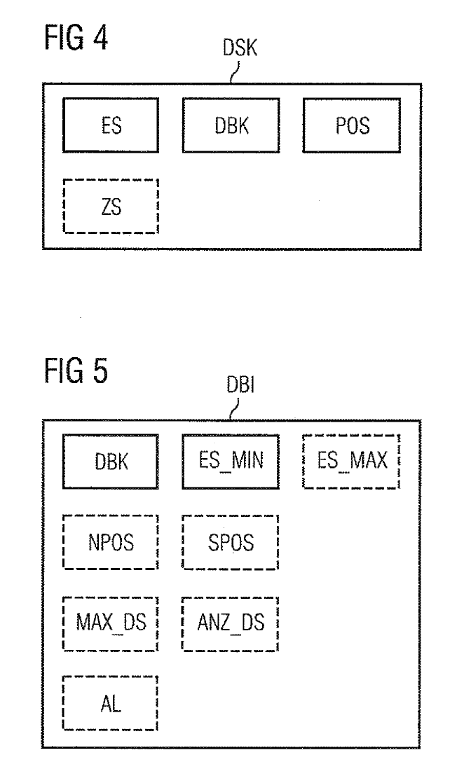

FIG. 4 shows the data record identifier DSK. The data record identifier DSK from the respective data record DS comprises an explicitness stamp ES, a data area identifier DBK and a logical position POS for the respective data record DS within the respective prescribed data area. In addition, the data record identifier DSK may also comprise a time stamp ZS which is preferably produced by the realtime clock RTC. The explicitness stamp ES is in a form such that it is respectively explicit for each data record DS and the respective prescribed data area. This involves an explicitness stamp ES which has already been used and has become invalid in the associated, prescribed data area not being used again for a new data record DS, and a new explicitness stamp ES, previously unused in the associated, prescribed data area, being produced and used for a data record DS which has been changed. Preferably, the explicitness stamp ES is in the form of a serial number, for example from the set of integer numbers or from the set of natural numbers. However, the explicitness stamp ES may also be in another form, for example in the form of a modified time stamp. The modification is provided in order to prevent the same explicitness stamp ES from occurring repeatedly when the clock time is reset. The data area identifier DBK is an explicit reference to the prescribed data area with which the respective data record DS is associated.

FIG. 5 shows the data area information item DBI. The data area information item DBI comprises the data area identifier DBK and information relating to at least one range of values for the explicitness stamps ES of the data records DS currently stored in the respective prescribed data area. This information item comprises, in particular, an explicitness stamp ES_MIN with the smallest value of all the data records DS currently stored in the associated data area. In addition, this information item may also comprise an explicitness stamp ES_MAX with the largest value of all the data records DS stored in the associated data area. The explicitness stamp ES_MIN with the smallest value and explicitness stamp ES_MAX with the largest value prescribe a range of values for the explicitness stamps ES. Explicitness. stamps ES are valid only if they are within such a range of values. By erasing, changing or adding data records DS to the respective prescribed data area, the information item relating to the at least one range of values for the explicitness stamps ES in the data area information item DBI is adjusted as appropriate. In particular, provision may be made for two or more ranges of values for the explicitness stamps ES to be provided in the respective data area information item DBI if a succession of the explicitness stamps ES of the data records DS in the respective prescribed data area has one or more gaps. Such a gap may arise as a result of erasure of a data record DS or of a plurality of data records DS, . In this case, erasure is also intended to be understood to mean that the data record DS to be erased is marked as erased or invalid. The respective data record DS also becomes invalid, by virtue of its explicitness stamps ES not being within the at least one range of values for the explicitness stamps ES. A plurality of ranges of values for the explicitness stamps ES can be stored or read as a concatenated list or as plurality of concatenated lists, for example.

Alternatively, or in addition, an exclusion list AL may be provided which is associated with the respective data area information item DBI. The exclusion list AL records erased data records DS, that is to say data records which have become invalid. The respective explicitness stamp ES is entered in the exclusion list AL. Provision may also be made for a range of values for explicitness stamps ES which have become invalid to be entered into the exclusion list AL for the respective data record DS which has become invalid or for a range of values for explicitness stamps ES which have become invalid which is already entered in the exclusion list AL to be extended on the basis of the explicitness stamp ES for that data record DS which needs to be marked as invalid. Hence, a data record DS is valid only if its associated explicitness stamp ES is within the at least one range of values for the explicitness stamps ES and its associated explicitness stamp ES is not entered in the exclusion list AL. The exclusion list AL is preferably stored securely or in protected form in order to prevent unauthorized manipulation of the exclusion list AL.

It is advantageous to provide the respective data area information item with a most recent position NPOS for the last stored data record DS in the associated, prescribed data area and/or with a write position SPOS for the next position POS to be written to in the associated, prescribed data area and/or with a number ANZ_DS of data records DS which are currently stored in the associated, prescribed data area and/or with the maximum number MAX_DS of data records DS which can be stored in the associated, prescribed data area. By providing this information in the respective data area information item DBI, the access to the data records DS in the associated, prescribed data area can be effected particularly easily and quickly. It is not necessary for all of this information to be provided in the data area information item DBI. By way of example, the maximum number MAX_DS of data records DS which can be stored in the respective prescribed data area can also be firmly encoded in a program which performs the protected writing and/or reading. In addition, the write position SPOS can possibly be ascertained from other information, particularly if the at least one prescribed data area is in the form of a ring memory. By way of example, the write position SPOS which is ascertained may be the position POS which comes after the most recent position NPOS taking account of the maximum number MAX_DS of data records DS. In addition, the explicitness stamp ES_MAX with the largest value can possibly be ascertained on the basis of the most recent position NPOS and the write position SPOS, and therefore does not need to be provided. In addition, the most recent position NPOS and the write position SPOS possibly do not need to be provided if the number ANZ_DS of data records DS in the associated prescribed data area is provided.

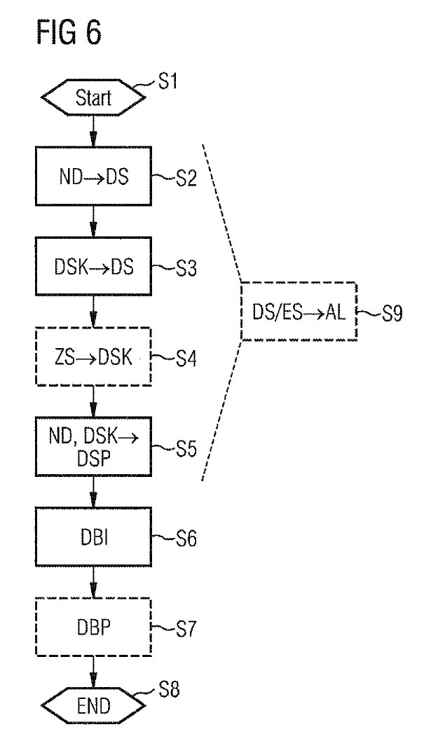

FIG. 6 is a flowchart for the protected writing of user data ND. The program starts in a step S1. In a step S2, the user data ND is stored in at least one data record DS. The respective data record DS is associated with a prescribed data area. By way of example, this association is made based on the data type or the data structure of the user data ND to be stored. In a step S3, the respective data record identifier DSK is produced and stored for the respective data record DS. In a step S4, provision is made for the time stamp ZS to be produced and stored in the respective data record identifier DSK.

In a step S5, the respective data record test value DSP is ascertained based on the respective user data ND and the respective data record identifier DSK. The respective data record test value DSP is stored for the respective data record DS. In a step S6, the respective data area information item DBI from the respective associated, prescribed data area is produced and stored or, if it has already been stored, updated. This relates particularly to the information item about the at least one range of values for the explicitness stamps ES and possibly the most recent position NPOS, the write position SPOS and/or the number ANZ_DS of data records DS. The data area information item DBI is preferably stored securely in the secure memory SMEM or in a protected form in the data memory DMEM. In the latter case, the respective or common data area test value DBP is produced in a step S7 and is stored securely in the secure memory SMEM. The program ends in a step S8.

A step S9 may also be provided which is executed instead of steps S2 to S5, to erase or mark as invalid a data record DS or two or more data records DS. By way of example, the respective data record DS is recorded in the exclusion list AL by entering the respective explicitness stamp ES or by entering or adjusting a range of values or a plurality of ranges of values for explicitness stamps ES which have become invalid.

The data stored in this manner is used to check an integrity of the user data ND. It is thus possible to recognize manipulation of user data ND or data record identifier DSK and/or possibly of data area information items DBI, that is to say an infringement of the integrity of the user data ND. The check is performed during the protected reading of the user data ND.

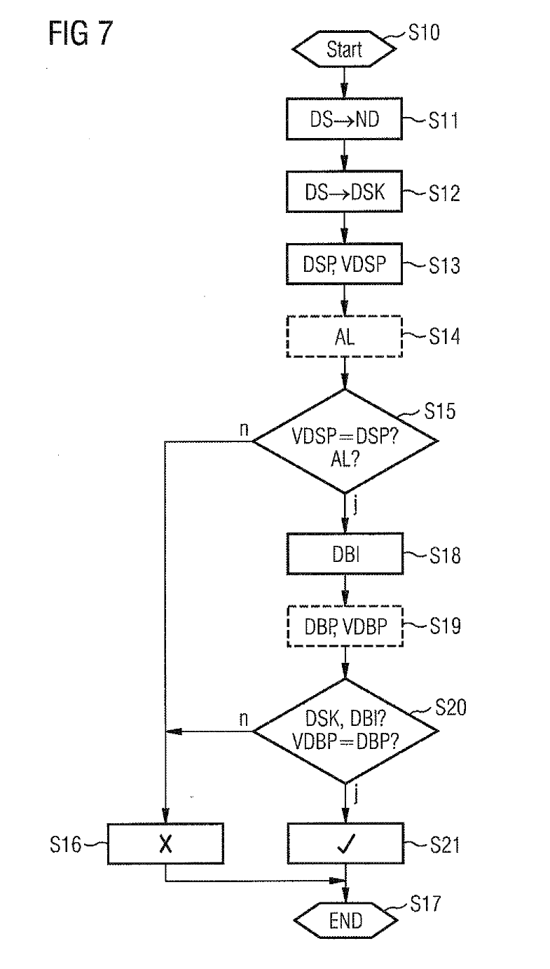

FIG. 7 is a flow chart for the protected reading of user data ND. The program starts in a step S10. In a step S11, the user data ND is read from the respective data records DS. In addition, the data record identifier DSK from the respective associated data record DS is read in a step S12. In a step S13, the respective data record test value DSP from the respective data record DS is read. In addition, the user data ND which is read and the respective associated data record identifier DSK is taken as a basis for ascertaining a respective associated comparison data record test value VDSP. The comparison data record test value VDSP is preferably ascertained in the same way as the data record test value DSP is ascertained for the protected memory for the user data ND. However, this is dependent on the type of data record test value DSP. In addition, in a step S14, provision may be made for the exclusion list AL which is associated with the data area information item DBI from the associated prescribed data area to be read, and possibly to be checked for integrity.

In a step S15 a check is performed to determine whether the comparison data record test value VDSP is the same as the data record test value DSP. In addition, a check can be performed in S15 to determine whether the respective data record DS is recorded in the exclusion list AL. If the ascertained comparison data record test value VDSP is not the same as the respective data record test value DSP or if the respective data record DS is recorded in the exclusion list AL then the program is continued in a step S16, in which it is established that the integrity of the user data ND has been infringed. The program then ends in a step S17.

If the comparison data record test value VDSP is the same as the data record test value DSP in step S15, and if the respective data record DS is not recorded in the exclusion list AL then the program is continued in a step S18. In step S18, the data area information item DBI from the associated, prescribed data area is read. If appropriate, there is provision in a step S19 for the respective or common data area test value DBP to be read and for a comparison data area test value VDBP to be ascertained in line with the data area test value DBP. In a step S20 a check is performed to determine whether the information in the data record identifier DSK and in the data area information item DBI is plausible. By way of example, a check is performed to determine whether the explicitness stamp ES stored in the data record identifier DSK is within the at least one range of values for the explicitness stamps ES. In addition, a check is performed to determine whether the data area identifier DBK matches. In addition, a check is preferably performed to determine whether the respective position POS which is stored in the respective data record identifier DSK respectively corresponds to the actual position POS of the respective data record DS in the respective associated, prescribed data area. In addition, a check can be performed to determine whether the comparison data area test value VDBP is the same as the data area test value DBP. If the information in the data record identifier DSK and in the data area information item DBI is not plausible or the comparison data test area value VDBP and the data area test value DBP do not match then the program is continued in step S16 and is ended in step S17. Otherwise, the program is continued in a step S21, in which it is established that the integrity of the user data ND is there and there is a high probability the said user data have not been manipulated. The program ends in step S17.

The order for the respective steps of the programs shown in FIG. 6 and FIG. 7 may also be in another form. For example, a read order for the user data ND, for the data record identifier DSK, for the data area information item DBI, for the data record test value DSP, and for the data area test value DBP is unimportant. In addition, a test order may also be different, that is to say that checks in S15 and S20 can be performed in another order. Accordingly a write order for the user data ND, for the data record identifier DSK, for the data area information item DBI, for the data record test value DSP and for the data area test value DBP is also unimportant.

The protected storage of the user data ND and the protected reading of the user data ND mean that manipulations on the user data ND can be recognized easily and reliably. The recognizable manipulations include changes to the user data ND, to the data record identifier DSK and possibly to the data area information item DBI. In addition, the manipulations may include changes to the position POS of data records DS within their associated prescribed data area, interchange of data records DS between different prescribed data areas and interchange of data area information items. In addition, what are known as replay attacks are recognizable by virtue of the explicitness stamp ES and the allowance for the information relating to the at least one range of values for the explicitness stamps ES within the associated, prescribed data area.

One advantage is that computation-intensive, cryptographic calculations need to be performed only over small volumes of data for ascertaining the respective data record test value DSP and comparison data record test value VDSP and possibly for ascertaining the respective or common data area test value DBP and comparison data area test value VDBP. Simulations have shown that a period of time which needs to be involved for integrity protection can be reduced by a factor of about two to three, for large volumes of data by the protected writing or the protected reading based on the above embodiments. Access to a respective data record DS, that is the protected writing or the protected reading of the respective data record DS, can be effected particularly quickly. The protected writing and the protected reading based on the above embodiments is especially advantageous particularly when the data records DS stored in protected form are not subject to changes, or subject only to rare changes.

The protected writing and/or the protected reading on the above embodiments can be used not only in tachographs TCO. Other apparatuses in the automotive sector, for example controllers, or in another technical sector can likewise benefit from the protected writing and/or protected reading. By way of example, it is also possible for program code and/or families of characteristic curves and/or data other than the user data ND to be written and/or read in correspondingly protected form.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-11. (canceled)

12. A method for protected storage of user data comprising:
storing the user data in at least one data record in at least one respective prescribed data area;
assigning the at least one data record a respective data record identifier, wherein the data record identifier comprises:
an explicitness stamp that is explicit in the respective prescribed data area;
an explicit data area identifier for the prescribed data area in which the respective data record is stored; and
a logical position for the respective at least one data record within the respective prescribed data area where the data record identifier is stored;
ascertaining a data record test value from the respective data record for the user data and the respective associated data record identifier;
storing the ascertained data record test value;
assigning a data area information item to the respective prescribed data area, wherein the data area information item comprises the data area identifier from the respective prescribed data area and information relating to at least one range of values for the explicitness stamp stored in the respective prescribed data area; and
storing the respective data area information item in at least one of a secure form and a protected form.

13. The method as claimed in claim 12, wherein the storing of the respective data area information item comprises:
ascertaining a common or respective data area test value for at least one data area information item from at least one prescribed data area; and
storing securely or in protected form, the common or respective data area test value for the at least one data area information item from the at least one prescribed data area.

14. The method as claimed in claim 12, wherein the respective prescribed data area has an associated exclusion list for data records that have become invalid, the method further comprising:
recording the respective data record which has become invalid in the exclusion list; and
stored securely or in protected form the exclusion list.

15. The method as claimed in claim 14, wherein recording of the respective data record that has become invalid in the exclusion list comprises at least one of:
entering the associated explicitness stamp into the exclusion list, and
entering at least one range of values for explicitness stamps that have become invalid into the exclusion list or adding it to the exclusion list based at least in part on the explicitness stamp.

16. The method as claimed in claim 12, further comprising ascertaining and storing a current time stamp in the respective data record identifier.

17. A method for the protected reading of user data, comprising:
reading the user data from at least one data record, the data record being stored in at least one prescribed data area;
reading a data record identifier associated with the at least one data record, said data record identifier comprising:
an explicitness stamp that is explicit in the respective prescribed data area;
an explicit data area identifier for the prescribed data area in which the respective data record is stored; and
a logical position for the respective data record within the respective prescribed data area;
reading a data record test value for the user data and the associated data record identifier from the respective data record;
storing the data record test value;
ascertaining an appropriate comparison data record test value based at least in part on the data record test value;
reading a data area information item associated with the respective prescribed data area, said data area information item comprising:
the data area identifier from the respective prescribed data area; and
information relating to at least one range of values for the explicitness stamps of the data records currently stored in the respective prescribed data area, and
checking integrity for the user data from the respective read data record based at least in part on:
the respective data record identifier,
the respective data record test value,
the respective comparison data record test value, and
the associated data area information item.

18. The method as claimed in claim 17, further comprising
reading at least one common or respective data area test value for at least one data area information item from at least one prescribed data;
ascertaining a respective corresponding common or respective comparison data area test value for the at least one data area information item from the at least one prescribed data area; and
checking an integrity of the user data in the respective data record based at least in part on at least one of the at least one read data area test value and the at least one comparison data area test value.

19. The method as claimed in claim 17, further comprising:
searching an exclusion list for data records that have become invalid which is associated with the respective prescribed data area for recording of the respective read data record; and
checking integrity of the user data in the respective data record based at least in part on the data records recorded in the exclusion list that have become invalid.

20. The method as claimed in claim 19, wherein the integrity of the user data in the respective data record is checked based at least in part on at least one of:
the explicitness stamps that have become invalid and are entered in the exclusion list, and
at least one range of values for explicitness stamps which have become invalid which is entered in the exclusion list.

21. An apparatus for the protected storage of user data comprising:
a memory configured to store the user data in at least one data record in at least one prescribed data area;
a first unit configured to respectively assign and store a data record identifier to the at least one data record, said data record identifier comprising:
an explicitness stamp that is explicit in the respective prescribed data area; and
an explicit data area identifier for the prescribed data area in which the respective data record is stored and a logical position for the respective data record within the respective prescribed data area;
a second unit configured to ascertain a data record test value for the user data and the respective associated data record identifier from the respective data record and to store the respective data record test value; and
a third unit configured to assign a data area information item to the respective prescribed data area and to store the respective data area information itemin at least one of a secure form and a protected form, the data area information item comprising:
the data area identifier from the respective prescribed data area; and
information relating to at least one range of values for the explicitness stamps of the data records currently stored in the respective prescribed data area.

22. An apparatus for the protected reading of user data comprising:
a first unit configured to read the user data from at least one data record that is stored in at least one logical data area;
a second unit configured to read a data record identifier that is associated with the at least one data record comprising:
an explicitness stamp that is explicit in the respective prescribed data area;
an explicit data area identifier for the prescribed data area in which the respective data record is stored; and
a logical position for the respective data record within the respective prescribed data area; and
a third unit configured to read a data record test value stored for the user data and the associated data record identifier from the respective data record and to ascertain an appropriate comparison data record test value;
a forth unit configured to read a data area information item associated with the respective prescribed data area, the data area information item comprises:
the data area identifier from the respective prescribed data area; and
information relating to at least one range of values for the explicitness stamps of the data records currently stored in the respective prescribed data area, and
a fifth unit configured to check an integrity of the user data from the respective read data record based at least in part on at least one of:
the respective data record identifier,
the respective data record test value,
the respective comparison data record test value, and
the associated data area information item.

23. The apparatus according to claim 21, wherein each of the respective units is configured as a single integral unit.

24. The apparatus according to claim 22, wherein each of the respective units is configured as a single integral unit.
